(19) United States
(12) Patent Application Publication
(10) Pub. No.: US 2007/0024413 A1
(43) Pub. Date: Feb. 1, 2007

(54) Organic positive temperature coefficient thermistor

(75) Inventor: Kenryo Namba, Tokyo (JP)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 11/493,600

(22) Filed: Jul. 27, 2006

(30) Foreign Application Priority Data
Jul. 29, 2005 (JP) P2005-221732

(51) Int. Cl. H01C 7/13

(52) U.S. Cl. 338/22 R

(57) ABSTRACT

An organic positive temperature coefficient thermistor provided with a pair of opposing electrodes and a thermistor body situated between the pair of electrodes, wherein the thermistor body is composed of a cured resin composition comprising: a thermosetting resin; conductive particles; and a nucleating agent. Also, an organic positive temperature coefficient thermistor, wherein the thermistor body is composed of a cured resin composition comprising: a thermosetting resin which contains a crosslinkable compound with a mesogen group; and conductive particles.

### BACKGROUND OF THE INVENTION

1. Field of the Invention

The present invention relates to an organic positive temperature coefficient thermistor, and more specifically it relates to an organic positive temperature coefficient thermistor having the property of a drastically increased resistance value in a specific temperature range upon temperature increase, i.e. a PTC (Positive Temperature Coefficient) characteristic.

2. Related Background Art

Organic positive temperature coefficient thermistors are used, for example, in temperature detectors and self-regulating heaters, and they must have a steep rise in electrical resistance with a large rate of change when a PTC characteristic is exhibited, as well as adequately low resistance at room temperature.

Thermistor elements provided with organic positive temperature coefficient thermistors are known in the prior art, such as one comprising metal powder or carbon black dispersed in a thermoplastic resin such as polyethylene or polypropylene (U.S. Pat. No. 3,591,526) and one obtained by dispersing a fibrous conductive substance such as carbon fibers, graphite fibers, graphite intercalation compound fibers, metal fibers and ceramic fibers, in the cured product derived from a resin composition comprising a thermosetting resin such as an epoxy resin, polyimide, unsaturated polyester, silicone, polyurethane or phenol resin (U.S. Pat. No. 4,966,729).

However, organic positive temperature coefficient thermistors employing thermoplastic resins require crosslinking treatment or noncombustion treatment during the production process, and the process is therefore complicated. On the other hand, organic positive temperature coefficient thermistors employing thermosetting resins tend to have large variation in resistance, while it is difficult to reduce the resistance at room temperature. The present inventors have therefore proposed a technology for improving the rise in electrical resistance when a PTC characteristic is exhibited, as well as the resistance at room temperature, by using a thermistor body employing a thermosetting resin having spiked protrusions as conductive particles (Japanese Unexamined-Patent Publication HEI No. 5-198403).

### SUMMARY OF THE INVENTION

However, in the case of organic positive, temperature coefficient thermistors of the conventional art that employ thermosetting resins, repeated use of the thermistors results in alteration of its characteristics due to the thermal history of rising and falling temperature, causing the problem of increased room temperature resistance. In other words, these are still unsatisfactory from the standpoint of operating stability with repeated use.

It is therefore an object of the present invention to provide an organic positive temperature coefficient thermistor employing a thermosetting resin, which can maintain stable operation even with repeated use.

In order to solve the problems mentioned above, the organic positive temperature coefficient thermistor of the invention is provided with a pair of opposing electrodes and a thermistor body situated between the pair of electrodes, wherein the thermistor body is composed of a cured resin composition comprising a thermosetting resin, conductive particles and a nucleating agent.

Since the thermistor body of the organic positive temperature coefficient thermistor of the invention contains a nucleating agent, it can maintain stable operation even with repeated use.

In order to achieve this effect in a more prominent manner, the nucleating agent preferably contains at least one type of compound selected from among organic acid metal salts and benzylidene sorbitol.

The organic positive temperature coefficient thermistor of the invention is provided with a pair of opposing electrodes and a thermistor body situated between the pair of electrodes, wherein the thermistor body is composed of a cured resin composition comprising a thermosetting resin which contains a crosslinkable compound with a mesogen group, and conductive particles.

By using a crosslinkable compound with a mesogen group as the thermosetting resin, the organic positive temperature coefficient thermistor can maintain stable operation with repeated use.

It is believed that most cured resin compositions containing thermosetting resins are amorphous. In the case of the present invention, however, it is believed that the use of a nucleating agent or the use of a thermosetting resin containing a crosslinkable compound with a mesogen group results in fine crystallized sections being produced in the cured product. In this respect, the nucleating agent and the crosslinkable compound with the mesogen group have a common technical feature. Furthermore, the present inventors conjecture that when the thermistor is heated to exhibit a PTC characteristic the crystalline portions melt and that subsequent cooling of the thermistor leads to recrystallization of those portions, thereby improving the stability against repeated heating and cooling operation. However, the present invention is not limited to exhibiting this type of mechanism.

The thermosetting resin with a mesogen group preferably contains a polyepoxy compound with a mesogen group and multiple epoxy groups. This will yield an even more superior thermistor in terms of heat resistance and the like.

When using a crosslinkable compound with a mesogen group, the resin composition also preferably further contains a nucleating agent. This will result in a more notable synergistic effect of improved operating stability.

From the viewpoint of balance between change in resistance when the PTC characteristic is exhibited and low room temperature resistance, the aforementioned thermistor body preferably contains the conductive particles at 5 to 65 wt % with respect to the total weight of the thermistor body.

### BRIEF DESCRIPTION OF THE DRAWINGS

FIG. 1 is a perspective view of an embodiment of a thermistor according to the invention.

### DESCRIPTION OF THE PREFERRED EMBODIMENTS

Preferred embodiments of the invention will now be described in detail. However, the present invention is not limited to the embodiments described below.

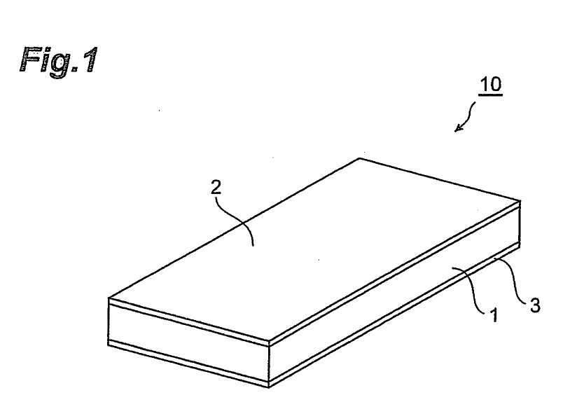

FIG. 1 is a perspective view that schematically illustrates a preferred embodiment of a thermistor according to the invention. The thermistor 10 shown in FIG. 1 is composed of a pair of electrodes 2 and 3 situated opposing each other and a thermistor body 1 between the electrodes 2 and 3 and closely bonded with each electrode, and it has an approximately rectangular solid shape overall. If necessary, the thermistor 10 is also provided with a lead (not shown) electrically connected to the electrode 2 and a lead (not shown) electrically connected to the electrode 3. The thermistor 10 is a organic positive temperature coefficient thermistor exhibiting a PTC characteristic, and it can be suitably used as an overcurrent/heat-protecting element, a self-regulating heating unit, a temperature sensor or the like.

The electrode 2 and electrode 3 are formed of a conductive material that functions as an electrode for the thermistor. The material composing the electrode. 2 and electrode 3 is preferably a metal such as nickel, silver, gold, aluminum or the like, or carbon. The thickness is preferably 1 to 100 μm, and from the viewpoint of reducing the weight of the thermistor it is more preferably 1 to 50 μm. At least one of the electrodes 2 and 3 is preferably roughened on the side of the thermistor body 1. The shapes and materials of the leads are not particularly restricted so long as they have electrical conductivity allowing release or injection of charge from the electrode 2 and electrode 3 to the outside.

The thermistor body 1 is consisted of a cured resin composition containing a thermosetting resin and conductive particles. The cured resin composition is formed when the thermosetting resin forms a crosslinked structure.

The resin composition either contains a nucleating agent, or the thermosetting resin including a crosslinkable compound with a mesogen group. Alternatively, the resin composition may contain both a nucleating agent and a crosslinkable compound with a mesogen group.

The nucleating agent is not particularly restricted so long as it is one that is known as a nucleating agent used to accelerate crystallization and to control crystal size, forming crystal nuclei during the process of cooling solidification of the crystalline polymer from a molten state. Nucleating agents are sometimes referred to as “nucleators”. The nucleating agent is disperse,d as particles in the thermistor body 1.

The nucleating agent preferably consists of particles containing at least one type of compound selected from among organic acid metal salts and benzylidene sorbitol. As specific preferred examples of organic acid metal salts there may be mentioned benzoic acid salts such as sodium benzoate and aluminum bis-(p-butylbenzoate), sodium-2,2′-methylene-bis-(4,6-di-t-butylphenyl)phosphate represented by formula (3) below (for example, ADEKASTAB NA-11 (trade name) by Adeka Corp.) and phosphoric acid ester metal salts such as ADEKASTAB NA-21 (trade name) by Adeka Corp.

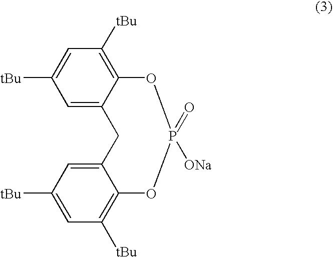

As benzylidenesorbitols there may be mentioned dibenzylidenesorbitol, bis(p-methylbenzylidene)sorbitol and bis(p-ethylbenzylidene)sorbitol. Commercially available nucleating agents containing benzylidenesorbitol include “Millad 3988” (trade name of Milliken Chemical) and “Gelol MD” (trade name of New Japan Chemical Co., Ltd.). When a nucleating agent is used, the amount is preferably 0.04 to 0.3 wt % with respect to the total weight of the thermistor body.

The thermosetting resin is a resin containing one or two or more different crosslinkable compounds, and it may form a crosslinked structure by curing reaction optionally in the presence of a curing agent or curing catalyst. As thermosetting resins there may be mentioned resins containing crosslinkable compounds with a plurality of crosslinkable functional groups, such as epoxy resins, polyimides, unsaturated polyesters, silicones, polyurethanes and phenol resins. The resin composition containing the thermosetting resin is cured by heat or the like to form a cured resin.

The thermosetting resin contains a crosslinkable compound with a mesogen group and a plurality of crosslinkable functional groups, and most preferably it contains a polyepoxy compound with a mesogen group and a plurality of epoxy groups. The proportion of the crosslinkable compound with the mesogen group is preferably 25 to 100 wt % with respect to the total thennosetting resin.

The mesogen group has a chemical structure such that it is known to be able to form a crystal phase by orientation of multiple groups, as typified by the structure of liquid crystal molecules. As examples of mesogen groups there may be mentioned groups obtained by elimination of hydrogen from biphenyl, phenyl benzoate, naphthalene, anthracene, azobenzene or stilbene, and these groups may optionally have substituents. More specifically, there are preferred divalent groups represented by the following chemical formulas (11) or (12).

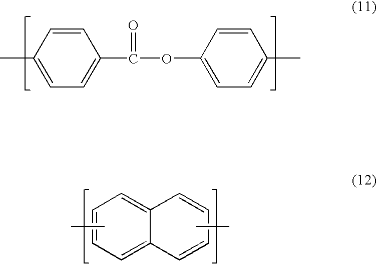

The crosslinkable compound with a mesogen group may have one or more mesogen groups. For example, in the case of a crosslinkable compound having an epoxy group and a mesogen group, it may be represented by “E-M-E” or “E-M-S-M-E”, where “E” is a substituent with an epoxy group, “M” is a mesogen group and “S” is a spacer group such as an alkylene group or oxyalkylene group. These compounds can be synthesized by known processes such as, for example, reaction between a compound with a phenolic hydroxyl group and a mesogen group, and epichlorhydrin.

More specifically, as crosslinkable compounds with epoxy groups and mesogen groups there may be mentioned 4-(oxiranylmethoxy)benzoic acid-4,4′-[1,8-octanediylbis(oxy)]bisphenol ester, 4-(oxiranylmethoxy)benzoic acid-4,4′-[1,6-hexanediylbis(oxy)]bisphenol ester, 4-(oxiranylmethoxy)benzoic acid-4,4′-[1,4-butanediylbis(oxy)]bisphenol ester, 4-(4-oxiranylbutoxy)benzoic acid-1,4′-phenylene ester, 4,4′-biphenol diglycidyl ether and 3,3′,5,5′-tetramethyl-4,4′-biphenol diglycidyl ether. Particularly preferred are the polyepoxy compound (4-(oxiranylmethoxy)benzoic acid-4,4′-[1,8-octanediylbis(oxy)]bisphenol ester) represented by chemical formula (1) below and the polyepoxy compound represented by formula (2) below. In formula (2), each R independently represents hydrogen or a monovalent organic group. Epoxy resins containing polyepoxy compounds of formula (2) (where R is hydrogen) are commercially available as EX-A7035 (trade name) by Dainippon Ink & Chemicals, Inc. These polyepoxy compounds with mesogen groups may also be used in combination with other polyepoxy compounds such as bisphenol A-diglycidylether.

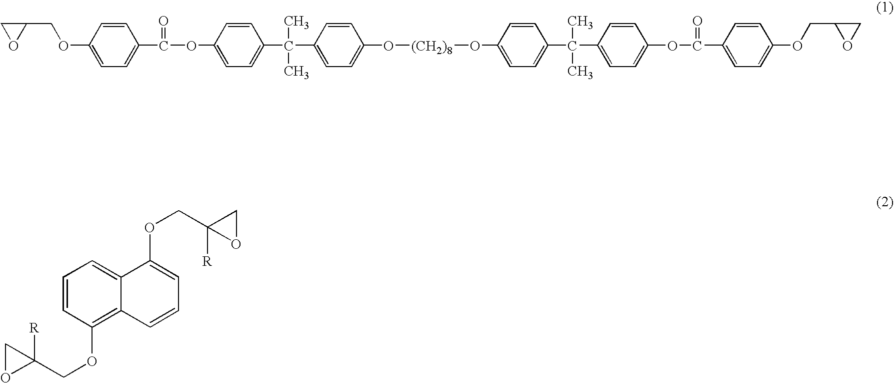

When a crosslinkable compound with multiple epoxy groups (a polyepoxy compound) is used as the thermosetting resin, it is preferred to used a curing agent in combination therewith. As curing agents in such cases there may be mentioned acid anhydrides, aliphatic polyamines, aromatic polyamines, polyamides, polyphenols, polymercaptanes, tertiary amines and Lewis acid complexes. Preferred among these are acid anhydrides and aromatic polyamines. When an acid anhydride is used, the thermistor tends to be able to exhibit a lower initial room temperature resistance and a larger change in resistance compared to using an amine-based curing agent such as an aliphatic polyamine.

As aromatic polyamines there are preferably used 4,4′-diaminodiphenylmethane, (DDM), 4,4′-diamminodiphenylether (DDE) 4,4′-diaminodiphenylsulfone (DDS), 4,4′-diamino-3,3′-dimethoxybiphenyl (DDB), 4,4′-diamino-α-methylstilbene (DSt), 4,4′-diaminophenylbenzoate (DBz) and the like.

As acid anhydrides there are preferred dodecenylsuccinic anhydride, methyltetrahydrophthalic anhydride, polyadipic anhydride, polyazelaic anhydride, polysebacic anhydride, poly(ethyloctadecanedioic) anhydride, poly(phenylhexadecanedioic) anhydride, ethyleneglycol bisanhydrotrimellitate, glycerol trisanhydrotrimellitate and the like.

As other specific examples of preferred acid anhydrides there may be mentioned 2,4-diethylglutaric anhydride, hexahydrophthalic anhydride, methylhexahydrophthalic anhydride, tetrahydrophthalic anhydride, phthalic anhydride, succinic anhydride, trimellitic anhydride, pyromellitic anhydride, methylnadic anhydride, maleic anhydride, benzophenonetetracarboxylic anhydride, endormethylenetetrahydrophthalic anhydride, methylendomethylenetetrahydropbthalic anhydride, methylbutenyltetrahydrophthalic anhydride, methylcyclohexenedicarboxylic anhydride, alkylstyrene-maleic anhydride copolymer, ethyleneglycol bistrimellitate, chlorendic anhydride and tetrabromophthalic anhydride.

These acid anhydrides may be used as curing agents either alone or in combinations.

The curing agent content may be appropriately set as suitable for the type of crosslinkable resin or curing agent. For example, when an acid anhydride is used as the curing agent in combination with a polyepoxy compound, the curing agent content is preferably such for an equivalent ratio of 0.5 to 1.5 and more preferably 0.8 to 1.2 with respect to epoxy groups in the polyepoxy compound. If the equivalent ratio of the curing agent is less than 0.5 or greater than 1.5 with respect to epoxy groups, the number of unreacted epoxy groups and acid anhydride groups will increase, thereby tending to lower the mechanical strength of the thermistor body and reduce the change in resistance of the thermistor.

The conductive particles are not particularly restricted so long as they are particles with electrical conductivity, and for example, there may be used carbon black, graphite, metal particles or ceramic-based conductive particles. As metal materials for metal particles there may be mentioned copper, aluminum, nickel, tungsten, molybdenum, silver, zinc, cobalt and nickel-plated iron powder. As ceramic-based conductive particle materials there may be mentioned TiC and WC. These conductive particles may be used alone, or two or more thereof may be used in combination.

Metal particles are particularly preferred as conductive particles. When metal particles are used as the conductive particles, the thermistor can maintain an adequately large change in resistance while exhibiting lower room temperature resistance and this is preferred if the thermistor of the invention is used, for example, as an overcurrent protecting element. Particularly preferred among metal particles are nickel particles, from the standpoint of chemical stability for resistance to oxidation and the like.

There are no particular restrictions on the shapes of the conductive particles, and there may be mentioned globules, flakes, fibers and rods. Spiked protrusions are preferably formed on the surfaces of the conductive particles. By using conductive particles having spiked protrusions, it is possible to facilitate the flow of tunnel current between adjacent particles, thereby ensuring adequate change in resistance of the thermistor while further lowering the room temperature resistance. Since the center distance between particles can be increased compared to spherical particles, it is possible to achieve an even larger change in resistance.

The conductive particles having spiked protrusions may consist of a powder having primary particles individually dispersed, but preferably about 10 to 1000 primary particles are linked in a chain to form filamentous secondary particles. The material is preferably a metal, and more preferably it is composed mainly of nickel. The conductive particles also preferably have a specific surface of 0.3 to 3.0 m²/g and an apparent density of no greater than 3.0 g/cm³. Here, the “specific surface” is the area-to-weight ratio determined by nitrogen gas adsorption method based on the BET single point method.

The mean particle size of the primary particles of the conductive particles is preferably 0.1 to 7.0 μm and more preferably 0.5 to 5.0 μm. The mean particle size of the primary particles is the value measured by the Fisher subsieve method.

As examples of commercially available conductive particles having spiked protrusions there may be mentioned INCO Type210, INCO Type255, INCO Type270 and INCO Type287 (all trade names of INCO, Corp.).

The content of the conductive particles in the resin composition is preferably 5 to 65 wt % and more preferably 20 to 55 wt % based on the total weight of the resin composition. If the conductive particle content is less than 5 wt %, it will tend to be difficult to obtain a low room temperature resistance, while if it exceeds 65 wt % it will tend to be difficult to obtain a large change in resistance.

In addition to the components mentioned above, the resin composition may also contain additives such as reactive diluents, plasticizers and the like. As reactive diluents there are particularly preferred monoepoxy compounds, for combination with a polyepoxy compound as the crosslinkable compound. As monoepoxy compounds there may be mentioned n-butylglycidyl ether, allylglycidyl ether, 2-ethylhexylglycidyl ether, styrene oxide, phenylglycidyl ether, cresylglycidyl ether, p-sec-butylphenylglycidyl ether, glycidyl methacrylate, tertiary carboxylic acid glycidyl esters and the like. As plasticizers there are preferred polyhydric alcohols such as polyethylene glycol and polypropylene glycol.

If necessary, there may also be added to the resin composition other components such as for example, thermoplastic resins, or low molecular organic compounds such as waxes, fats and oils, fatty acids and higher alcohols. The thermoplastic resin maybe dissolved in the resin composition, or it may be dispersed in the form of particles.

The resin composition may be obtained by combining the aforementioned constituent components using an apparatus such as a stirrer, dispenser, mill or the like. Here, an organic solvent such as an alcohol or acetone, or a reactive diluent or the like, may be added to the resin composition to reduce the viscosity. The mixing time is not particularly restricted, but normally the components can be homogeneously dissolved or dispersed by mixing for 10 to 30 minutes. The mixing temperature is also not particularly restricted and may be, for example, 25 to 80° C. The mixed resin composition is preferably degassed in a vacuum to remove air bubbles incorporated during mixing.

The thermistor 10 can be satisfactorily manufactured by a production process including a curing step wherein a sheet composed of the B-stage resin obtained by B-staging the aforementioned resin composition is heated between two opposing conductive layers to cure the resin composition and form a thermistor body 1. In this process, the two opposing conductive layers are the electrodes 2 and 3. A production process using such a B-stage resin sheet is preferred because it can be carried out using basically the same equipment as for production of a thermistor using a thermoplastic resin.

The sheet composed of a B-stage resin can be obtained by coating the resin composition onto a releasable film (a silicone surface-treated PET film or the like) and heating the coated film. The sheet is released from the releasable film and used in the curing step.

The heating conditions for the curing step may be appropriately adjusted depending on the type of thermosetting resin and curing agent, so as to adequately promote curing of the resin composition. The curing step may be carried out in two stages comprising precuring and subsequent main curing. The cured laminate is cut to obtain a sheet-like thermistor of the prescribed size.

The present invention will now be explained in greater detail by examples and comparative examples. However, the present invention is in no way limited to the examples.

### EXAMPLE 1

Prescribed amounts of an epoxy resin with no mesogen groups (“Araldite F” (trade name), product of Asahi Denka Co., Ltd.), a curing agent (“Hardner” (trade name), product of Ciba Geigy Co., Ltd.), a nucleating agent (“ADEKASTAB NA11” (trade name), product of Adeka Corp.) and filamentous Ni powder (product of Inco Corp., mean particle size by Fisher subsieve method: 2.2 to 2.8 μm) were mixed, and the mixture was stirred while degassing in a vacuum to prepare a resin composition. The resin composition was coated onto a releasable PET film and heated for B-staging of the resin composition to form a sheet made of the B-stage resin. The sheet released from the PET film was press molded between two Ni foils to obtain a laminate with the Ni foils attached to both sides of the sheet. Next, the B-stage resin was cured by precuring (80° C., 30 min) and main curing (140° C., 1 hr) to obtain a laminated body with a thermistor body. Finally, the laminated body was punched to obtain a sheet-like thermistor with a thickness of 0.8 mm, having a 5×3 mm main surface.

### EXAMPLE 2

Prescribed amounts of an epoxy resin containing a polyepoxy compound represented by formula (2) (“EXA7035”, product of Dainippon Ink Chemicals. Inc.) the curing agent “Hardner” and filamentous Ni powder (product of Inco Corp., mean particle size by Fisher subsieve method: 2.2 to 2.8 μm.) were mixed, and the mixture was stirred while degassing in a vacuum to prepare a resin composition. The obtained resin composition was used to manufacture a thermistor in the same manner as Example 1.

### EXAMPLE 3

Prescribed amounts of the epoxy resin “EXA7035”, the curing agent “Hardner”, the nucleating agent “ADEKASTAB NA11” and filamentous Ni powder (product of Inco Corp., mean particle size by Fisher subsieve method: 2.2 to 2.8 μm) were mixed, and the mixture was stirred while degassing in a vacuum to prepare a resin composition. The obtained resin composition was used to manufacture a thermistor in the same manner as Example 1.

### EXAMPLE 4

Prescribed amounts of a polyepoxy compound represented by formula (1), the curing agent “Hardner” and filamentous Ni powder (product of Inco Corp., mean particle size by Fisher subsieve method: 2.2-2.8 μm were mixed, and the mixture was stirred while degassing in a vacuum to prepare a resin composition. The obtained resin composition was used to manufacture a thermistor in the same manner as Example 1.

### COMPARATIVE EXAMPLE

Prescribed amounts of the epoxy resin “Araldite F”, the curing agent “Hardner” and filamentous Ni powder (product of Inco Corp., mean particle size by Fisher subsieve method: 2.2 to 2.8 μm) were mixed, and the mixture was stirred while degassing in a vacuum to prepare a resin composition. The obtained resin composition was used to manufacture a thermistor in the same manner as Example 1.

Thermistor Evaluation

Each thermistor prepared as described above was measured for initial room temperature (23° C.) resistance (initial resistance) and room temperature resistance after 1000 heat treatment procedures to produce a PTC characteristic (resistance after 1000 operations). The results are shown in Table 1.

TABLE 1

| | Thermosetting | Nucleating | Metal | Initial | Resistance after |
|---|---|---|---|---|---|
| | resin | agent | particles | resistance | 1000 operations |
| Example 1 | Araldite F | ADEKAST | Filamentous | 5 mΩ | 9 mΩ |
| | | AB NA11 | Ni powder | | |
| Example 2 | EXA-7035 | — | same as | 6 mΩ | 7 mΩ |
| | | | above | | |
| Example 3 | same as | ADEKAST | same as | 5 mΩ | 5 mΩ |
| | above | AB NA11 | above | | |
| Example 4 | Compound | — | same as | 5 mΩ | 6 mΩ |
| | of formula (1) | | above | | |
| Comparative | Araldite F | — | same as | 6 mΩ | 20 mΩ |
| Example | | | above | | |

As shown in Table 1, the thermistors of the examples employing a crosslinkable compound with a mesogen group and/or a nucleating agent essentially maintained the initial resistance even after 1000 operations, and were therefore confirmed to exhibit sufficient operating stability. In contrast, the thermistor of the comparative example which used an epoxy resin with no mesogen group and did not include a nucleating agent had significantly increased resistance after 1000 operations.

According to the invention, there is provided a thermistor employing a thermosetting resin, and capable of maintaining stable operation even after repeated use. The invention also provides a thermistor with minimal variation in temperature rise when exhibiting a PTC characteristic.

What is claimed is:

1. An organic positive temperature coefficient thermistor provided with a pair of opposing electrodes and a thermistor body situated between said pair of electrodes,
wherein said thermistor body is composed of a cured resin composition comprising: a thermosetting resin; conductive particles; and a nucleating agent.

2. An organic positive temperature coefficient thermistor according to claim 1,
wherein said nucleating agent contains at least one type of compound selected from among organic acid metal salts and benzylidene sorbitol.

3. An organic positive temperature coefficient thermistor according to claim 1,
wherein said thermistor body contains said conductive particles at 5 to 65 wt % with respect to the total weight of said thermistor body.

4. An organic positive temperature coefficient thermistor provided with a pair of opposing electrodes Sand a thermistor body situated between said pair of electrodes,
wherein said thermistor body is composed of a cured resin composition comprising: a thermosetting resin which contains a crosslinkable compound with a mesogen group; and conductive particles.

5. An organic positive temperature coefficient thermistor according to claim 4,
wherein said crosslinkable compound with a mesogen group is a polyepoxy compound with a mesogen group and multiple epoxy groups.

6. An organic positive temperature coefficient thermistor according to claim 4,
wherein said resin composition further contains a nucleating agent.

7. An organic positive temperature coefficient thermistor according to claim 4,
wherein said thermistor body contains said conductive particles at 5 to 65 wt % with respect to the total weight of said thermistor body.
